(19) United States
(12) Patent Application Publication
(10) Pub. No.: US 2013/0105653 A1
(43) Pub. Date: May 2, 2013

(54) Device for Hanging and Storing Articles

(71) Applicant: Robert Borys, (US)

(72) Inventor: Robert Borys, (US)

(21) Appl. No.: 13/284,019

(22) Filed: Oct. 28, 2011

(51) Int. Cl. F16B 45/00

(52) U.S. Cl. 248/304

(57) ABSTRACT

A device for hanging and storing articles. The device comprises a track and one or more hooks releasably securable thereto. The track includes a downwardly oriented longitudinal lip and a longitudinal rib. The longitudinal lip forms a downwardly orientated longitudinal channel. The hook includes a flange member and a recess. The flange member of the hook is receivable within the downwardly oriented channel of the track and the recess of the hook is receivable about the longitudinal rib of the track to releasably secure the hook to the track.

### FIELD

The invention relates to a device for hanging and storing articles, and in one particular embodiment to a track having releasably securable thereto one or more hooks.

### BACKGROUND

For many reasons it is often desirable to hang or store a wide variety of different types of articles from a vertical surface, such as a wall or the back of a door. The types of articles that may be so stored include hand tools, garden implements, clothing, sports equipment (including hockey equipment), footwear, extension cords, etc. In some cases it is desirable to store articles semi-permanently so that they are retained in a neat and organized manner. In other instances it is desirable to store articles on a temporary basis, such as would be the case when articles are wet and are hung to dry.

Others have devised a very wide variety of different hooks, tracks and other similar devices that may be secured or otherwise attached to vertical surfaces for purposes of hanging or storing articles. While in most instances such devices perform an adequate job of retaining the articles for which they are designed, each generally carries with it one or more drawbacks. For example, in many instances where the device contains multiple hooks, the hooks are in a fixed position, reducing the flexibility of the device to accommodate a wide range of different types and sizes of articles. In other instances, although the hooks are not permanently fixed in position they are held in place through the use of mechanical fasteners that are cumbersome to operate or that require the use of hand tools in order to secure or re-position the hooks. In still other cases, the nature and structure of the devices are such that they are relatively complex mechanically, which tends to increase their expense of manufacture. Further, where such devices incorporate more than one hook, the hooks tend to be mounted or oriented in a single horizontal plane which can prohibit or make it difficult to hang articles at different horizontal levels.

### SUMMARY

There is provided an improved device for hanging and storing articles that addresses a number of the deficiencies in pre-existing products.

In one aspect there is provided a device for hanging and storing articles, the device comprising a track and one or more hooks releasably securable thereto, said track including a downwardly oriented longitudinal lip and a longitudinal rib, said longitudinal lip forming a downwardly orientated longitudinal channel, said hook including a flange member and a recess, said flange member of said hook receivable within said downwardly oriented channel of said track and said recess of said hook receivable about said longitudinal rib of said track to releasably secure said hook to said track.

Further aspects and advantages will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is an upper front perspective view of a first configuration of the invention;

FIG. 2 is a side view of the configuration of the invention shown in

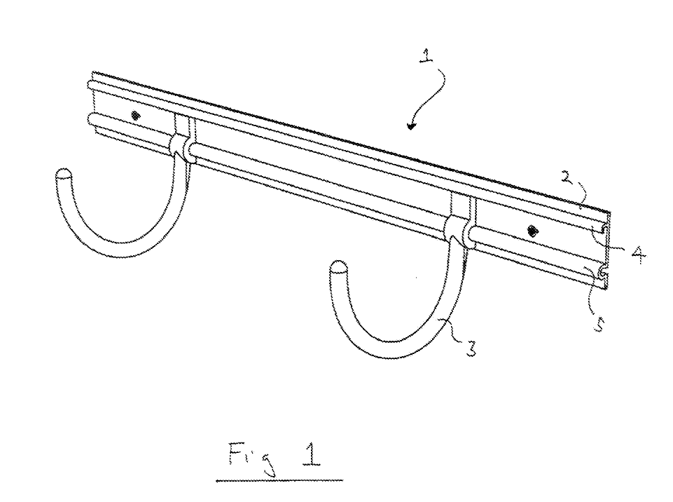

FIG. 1;

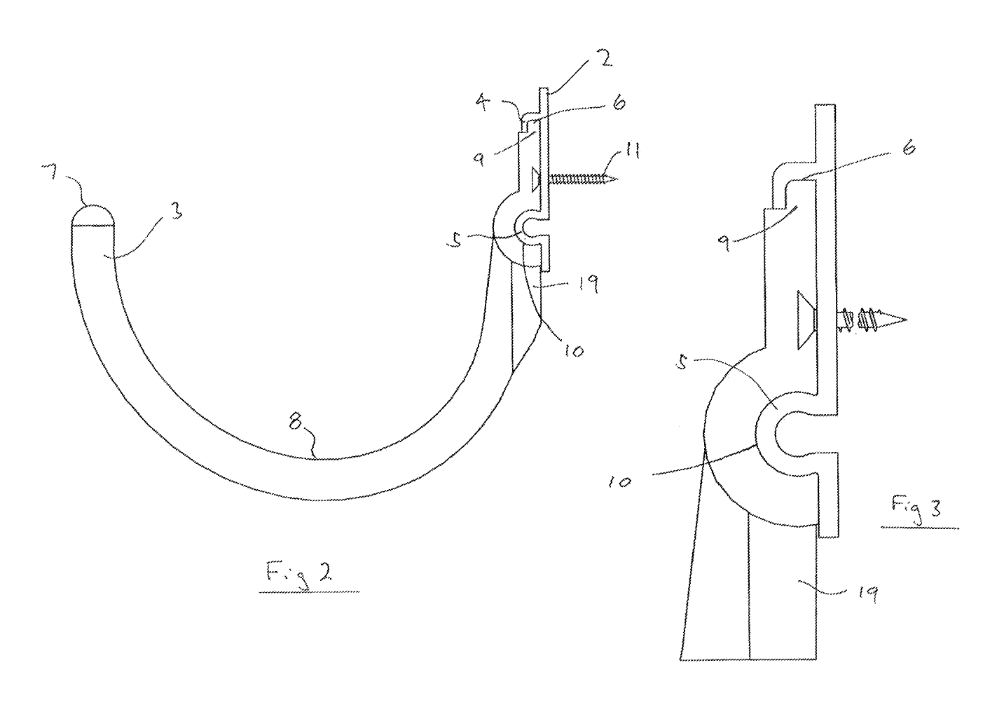

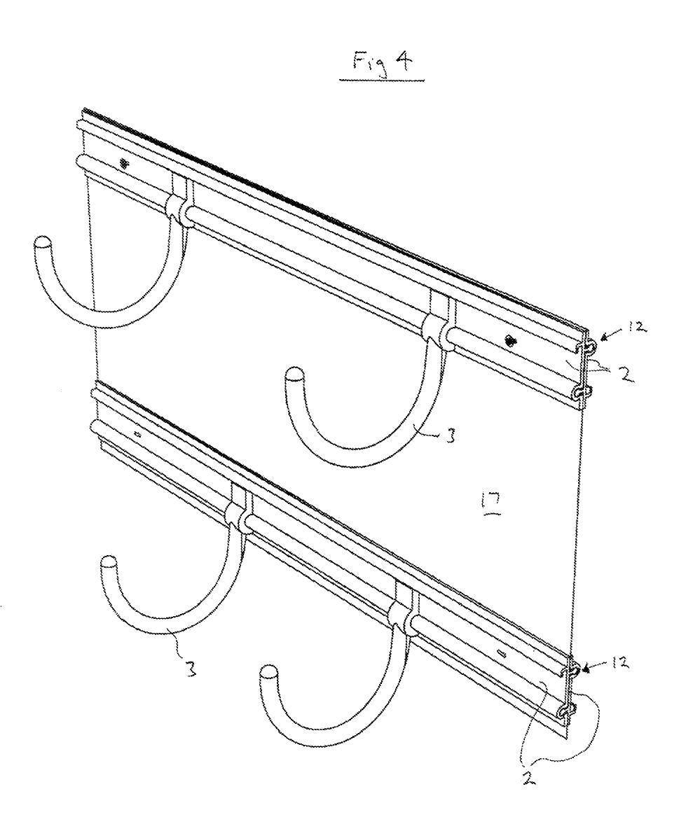

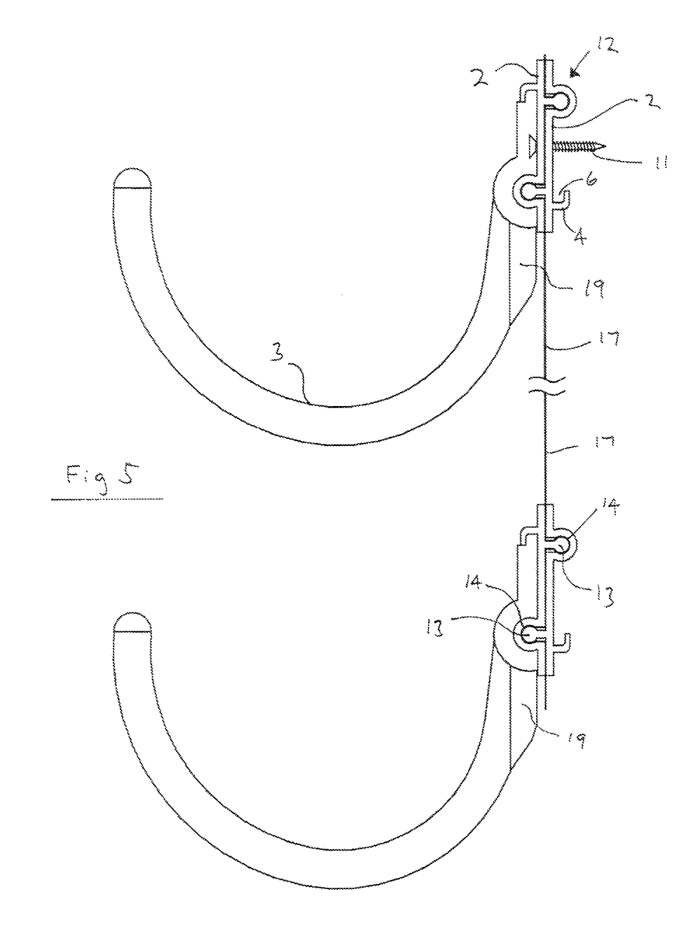

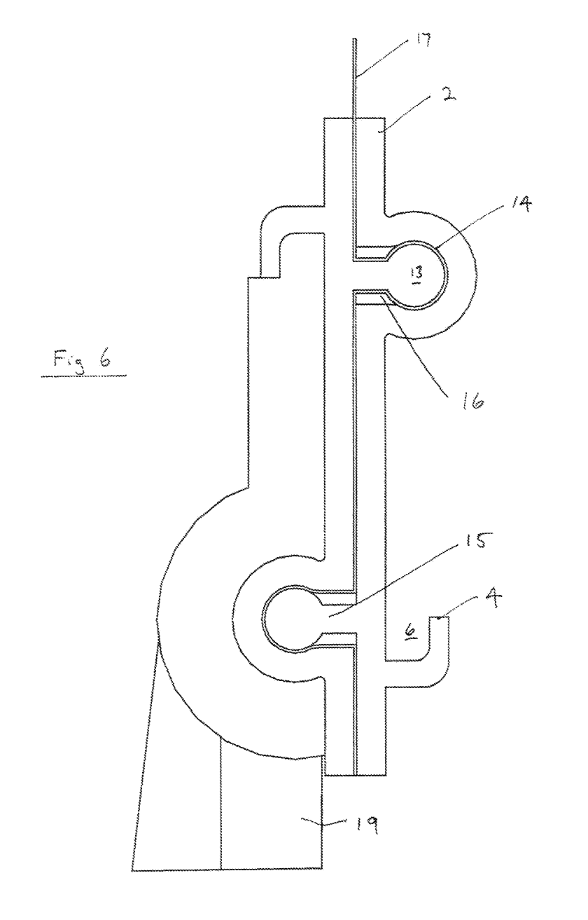

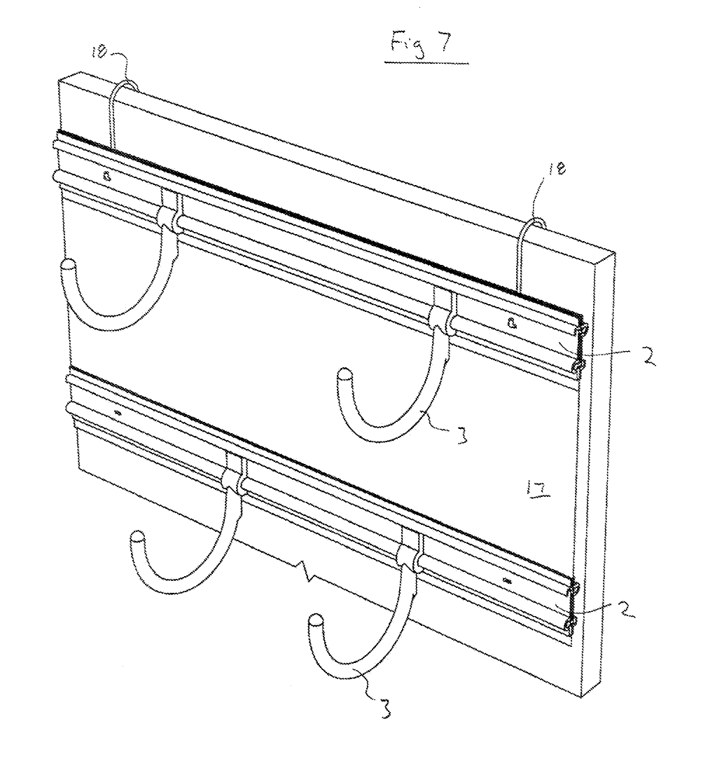

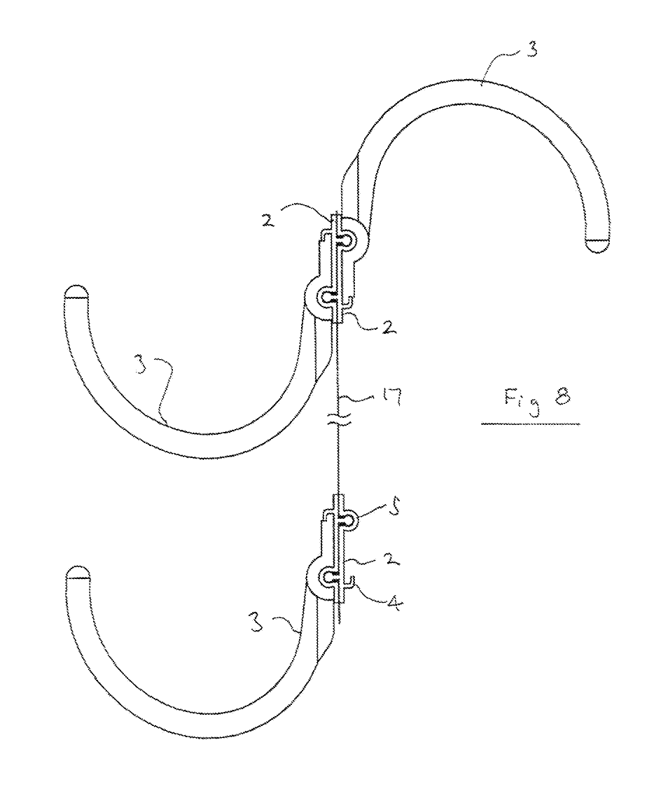

FIG. 3 is an enlarged detailed side view of the track and a portion of the hook shown in FIG. 2;

FIG. 4 is a side perspective view of an alternate configuration of the invention;

FIG. 5 is a side view of the configuration shown in FIG. 5;

FIG. 6 is an enlarged detailed side view of the track and a portion of the hook shown in FIG. 5;

FIG. 7 is an upper front perspective view of the configuration of the invention shown in FIG. 4 hung over the top of a door or similar rectangular panel; and,

FIG. 8 is a side view of an alternate configuration of the invention shown in FIG. 4.

### DESCRIPTION

The present invention may be embodied in a number of different forms. However, the specification and drawings that follow describe and disclose only some of the specific forms of the invention and are not intended to limit the scope of the invention as defined in the claims that follow herein.

Referring to the attached drawings, a first embodiment of the described device is shown in FIGS. 1 through 3. Here, device 1 for hanging and storing articles is shown as comprising a track 2 and one or more hooks 3. Two hooks are depicted, however, it will be appreciated that any number of hooks can be utilized at any desired spacing on any desired length of track.

With reference specifically to FIGS. 2 and 3, track 2 includes a downwardly oriented longitudinal lip 4 and a longitudinal rib 5. Longitudinal lip 4 forms a downwardly oriented longitudinal channel 6. Hook 3 includes a bill portion 7, a hook bowl 8, a flange member 9 and a recess 10. In the embodiment of the invention shown in the attached drawings, hook 3 is generally arcuate in shape. It should be appreciated that the word “hook” as used herein is intended to have a very broad meaning and simply designates a structural member of a shape and configuration that is able to present a means from which one or more articles can be stored or hung. For example, hook 3 may be in the form of what may be referred to as a double hook, a robe or garment hook, a utility hook, a peg, a coat hook, or various other specialized forms of hooks or hangers that are designed specifically to secure or store particular forms of tools, hand implements, clothing, etc. “Hook” 3 may also take the form of a shelf, basket, or other such device which may be releasably secured to track 2 in the manner described herein. Regardless of the specific nature of hook 3, it will in each instance contain a flange member 9 that is receivable within channel 6 of track 2. The hook will also include a recess 10 that is receivable about longitudinal rib 5 on the track in order to releasably secure the hook to the track.

In one aspect, recess 10 of hook 3 and longitudinal rib 5 of track 2 are generally circular in cross section and are dimensioned to allow the recess to be receivable about the rib through a “snap-fit”. Of course, other forms of ribs and recesses having different geometric shapes could also be utilized while still allowing for a snap-fit (or a sufficiently tight fit) between the hook and the track to permit the hook to be held securely on the track. Preferably, either hook 3 (or at least the portion of the hook containing recess 10), and/or longitudinal rib 5 of track 2 are flexibly resilient in order to allow for a snap-fit between the hook and the track, and to facilitate removal and repositioning of the hook along the length of the track. In one embodiment, both the hook and the rib are flexibly resilient.

It will thus be understood that with the receipt of flange 9 within channel 6, the lower portion of hook 3 can be pushed inwardly toward track 2 to cause recess 10 to be received over rib 5, thereby holding hook 3 securely in place on the track. Similarly, with flange 9 received within channel 6 the lower portion of the hook can be pulled away from track 2 to cause recess 10 to be removed from about rib 5 and to permit the hook to be re-located along the length of the track or to be removed completely. With the hook secured to the track, a vertical load applied to the hook will generally be transferred from the hook body (surrounding recess 10) to longitudinal rib 5, which will generally distribute the load along the length of the track. While a “snap” or close tolerance fit between recess 10 and rib 5 is desirable, it will be appreciated that other forms of interaction between the recess and the rib could be utilized. As shown in FIGS. 1 through 3, the track may be held in position upon a desired surface through the use of fasteners 11.

FIGS. 4 through 7 show a second configuration of the invention. In this configuration track 2 includes one or more fastening members 12 on its rear surface. The fastening members are oriented such that 2 sections (or lengths or portions) of track, when placed back to back, can be releasably secured together through the engagement of the fastening members on the two respective lengths of track. In the particular configuration shown in the drawings, fastening members 12 comprise a male portion 13 and a female portion 14 on the track's rear surface. Although one or more male and female portions may be utilized, in the embodiment depicted a single male portion, that is comprised of a longitudinal outwardly extending rail 15, and a single female portion, comprising a longitudinal inwardly extending and correspondingly configured and dimensioned channel 16, are present. It will thus be appreciated that first and second lengths or sections of track 2 may be releasably secured together through the mating of the respective rails 15 and channels 16 on their rear surfaces. In the embodiment of the device shown in the attached drawings rail 15 is substantially circular in cross section, as is channel 16. Preferably either one or both of rail 15 and channel 16 are flexibly resilient, permitting rails 15 to “snap” into channels 16 and thus releasably secure the two channel sections together.

Securing two track sections together in a back-to-back configuration will serve to help increase the rigidity of the pair of track sections. In addition, and as shown, securing two lengths of track together in the described fashion permits the insertion of a textile material 17 between the two track sections to releasably secure the textile to the two track portions when they are themselves releasably secured together. In such an instance the thickness of textile material 17 may be taken into account when determining the dimensions of rail 15 and channel 16 in order to allow the textile to be received about the rail before the rail is inserted into the channel.

Depending upon the desired application for device 1, a plurality of first and second track section pairs may be releasably secured to textile 17 at pre-determined spaced apart distances (see FIGS. 4 and 7). Such a structure permits a number of articles to be hung from a plurality of hooks 3 that may be positioned anywhere along the length of one or more track sections that are vertically spaced apart at a desired distance. Preferably, textile material 17 is of sufficient strength to enable the weight of any and all articles hung from hooks 3 located on any and all of the track sections through merely the insertion of fasteners through the uppermost pair of track sections. Alternately, and as shown in FIG. 7, the upper track section may be hung from the top surface of a door, other vertical panel, or generally any other vertical structure, through the use of hangers 18.

FIG. 8 shows a variation to the configuration of the device shown in FIG. 4. In this embodiment one or more hooks 3 are secured to the rear portion of the back to back lengths of track. It will be appreciated that in light of the nature of the track structure, the rear portion of the back to back lengths of track will be oriented such that outwardly extending rail 15 of the rear track section is at the top portion of the track with channel 16 situated on the lower portion of the track. In this manner one or more hooks 3, when secured thereto, will be oriented in the opposite direction to that of the hook or hooks positioned on the front track portion. Since the rear and the front track portions are identical (only reversed in orientation), hooks can be attached and removed from the rear track portion in precisely the same way that they are attached and removed from the front track portion. Typically, hooks will only be releasably secured to the rear track portion of the upper-most pair of back-to-back track sections to provide a means to hang the pair of tracks over the top of a door or other surface or structure. That is, in this configuration of the device hooks 3 can be utilized in place of hangers 18.

It will be appreciated that although track 2 and hooks 3 could be formed from a wide variety of materials. In most instances it is expected that the track will be an extruded plastic or other generally similar type of material, and that hooks 3 will be formed from molded plastic or other generally similar type of material. In such cases, in order to enhance the structural rigidity of the hook, and/or to help resist the tendency of the hook and the track to flex or rotate horizontally downwardly when loaded, the rear of the hook may include an outwardly extending set-off rib 19. A downward flexure of the hook, or a torsional rotation of the track, will generally cause rib 19 to come into contact (directly or indirectly) with the surface upon which the track is mounted, thereby helping to stabilize the hook, limit further flexure, and help to stabilize the position of the track against the surface on which it is located.

It will thus be appreciated from a thorough understanding of the described structure that there is provided an apparatus that allows for the simple placement of hooks along a track and at a desired spacing, while also presenting a means by which the hooks can be easily removed and repositioned in order to hang any one of an extremely wide variety of different articles. There is also presented the means to hang a series of spaced apart tracks from a single track, that itself may be secured to a surface. The multiple spaced-apart tracks provide a user with the ability to position a plurality of hooks in a variety of different horizontal and vertical locations, thereby enabling the user to hang articles in a vertically and horizontally spaced-apart configuration.

It is to be understood that what has been described are the preferred embodiments of the invention and that it may be possible to make variations to these embodiments while staying within the broad scope of the invention. Some of these variations have been discussed while others will be readily apparent to those skilled in the art.

I claim:

1. A device for hanging and storing articles, the device comprising a track and one or more hooks releasably securable thereto, said track including a downwardly oriented longitudinal lip and a longitudinal rib, said longitudinal lip forming a downwardly orientated longitudinal channel, said hook including a flange member and a recess, said flange member of said hook receivable within said downwardly oriented channel of said track and said recess of said hook receivable about said longitudinal rib of said track to releasably secure said hook to said track.

2. The device as claimed in claim 1 wherein said recess of said hook and said longitudinal rib of said track are dimensioned to form a snap fit.

3. The device as claimed in claim 1 wherein said recess of said hook and said longitudinal rib of said track are generally circular in cross section and are dimensioned to allow said recess to be receivable about said longitudinal rib through a snap-fit.

4. The device as claimed in claim 3 wherein at least one of the portion of said hook containing said recess and said longitudinal rib are flexibly resilient.

5. The device as claimed in claim 1 wherein said track includes one or more male and one or more female portions on its rear surface, said male and female portions oriented on said track such that first and second sections of track are releasably securable together in a back to back configuration through the mating of the one or more male portions on said first track section with the one or more female portions on said second track section, and through the mating of the one or more male portions on said second track section with the one or more female portions on said first track section.

6. The device as claimed in claim 5 wherein said one or more male portions of said track comprise one or more longitudinal outwardly extending rails, and said one or more female portions of said track comprise one or more longitudinal inwardly extending correspondingly configured and dimensioned channels.

7. The device as claimed in claim 5 wherein a textile material inserted between said first and second track sections is releasably secured to said first and second track sections when said one or more male portions of said first and second track sections are received within said one or more female portions of said first and second track sections.

8. The device as claimed in claim 7 including a plurality of first and second track section pairs releasably secured to said textile at pre-determined spaced-apart distances.

9. The device as claimed in claim 1 wherein said hook further includes a set-off rib extending outwardly from the rear of said hook, upon the loading of said hook said rib directly or indirectly bearing against a surface to which said track is mounted or from which said track is hung, thereby enhancing the structural rigidity of said hook and resisting the tendency of said hook and said track to flex or rotate horizontally downwardly.

10. The device as claimed in claim 1 wherein said track includes one or more fastening members on its rear surface, said fastening members oriented such that first and second sections of track are releasably securable in a back to back configuration through the engagement of their respective fastening members.

11. The device as claimed in claim 5 wherein said one or more male portions mate with said one or more female portions through a snap-fit.

12. The device as claimed in claim 5 wherein said one or more male portions of said track comprise a longitudinal, outwardly extending, rail, and said one or more female portions of said track comprise a longitudinal, inwardly extending, corresponding dimensioned, channel, said rail and said channel having a generally circular cross sectional configuration.

13. The device as claimed in claim 12 wherein one or both of said male portions and said female portions are flexibly resilient and mate through a snap fit.

14. The device as claimed in claim 5 wherein the longitudinal lip on said second section of track forms an upwardly oriented longitudinal channel, one or more hooks releasably securable to said second section of track through insertion of the flanges of the one or more hooks into said upwardly oriented channel and with said recesses of said one or more hooks receivable about the longitudinal rib of said second section of track, said one or more hooks on said second section of track oriented in the opposite direction to said hooks releasably secured to said first section of track.
